(19) United States
(12) Patent Application Publication
(10) Pub. No.: US 2025/0368441 A1
(43) Pub. Date: Dec. 4, 2025

(54) CONTAINER HANDLING VEHICLE

(71) Applicant: AutoStore Technology AS, Nedre Vats (NO)

(72) Inventor: Ingvar Fagerland, Kolnes (NO)

(21) Appl. No.: 18/874,445

(22) PCT Filed: Jun. 23, 2023
(86) PCT No.: PCT/EP2023/067085

§ 371 Date: Dec. 12, 2024

(30) Foreign Application Priority Data
Jun. 29, 2022 (NO) 20220737

(51) Int. Cl. B65G 1/06; B65G 1/04

(52) U.S. Cl. CPC B65G 1/065; B65G 1/0464

(57) ABSTRACT

The present invention provides a container handling vehicle (2) for moving in two perpendicular horizontal directions on a rail system, the rail system comprising a first set of parallel rails and a second set of parallel rails arranged perpendicular to the first set of rails, the container handling vehicle comprising a vehicle frame (4), a base (6), an internal space (5) defined by the vehicle frame (4) and the base (6), the base (6) providing at least one storage section upon which at least two storage containers stacked on top of each other may be supported, a lifting device comprising a vertically moveable lifting frame (7) for releasably connecting to a storage container and an opening (8) allowing vertical passage of the lifting frame (7) between the internal space (5) and a position below the base; wherein the lifting device is configured to be horizontally moveable between a position above the opening (8) and a position above the at least one storage section.

### FIELD OF THE INVENTION

The present invention relates to a container handling vehicle, a storage system comprising the container handling vehicle, and a method of retrieving storage containers in the storage system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201, 301, 401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a horizontal grid-based rail system 108 (i.e. a rail grid) arranged across the top of framework structure 100, on which rail system 108 a plurality of container handling vehicles 201, 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201, 301, 401 in a first direction X across the top of the frame structure 100, and a second set of parallel rails 111 arranged perpendicular to the first set of rails 110 to guide movement of the container handling vehicles 201, 301, 401 in a second direction Y which is perpendicular to the first direction X. Containers 106 stored in the columns 105 are accessed by the container handling vehicles 201, 301, 401 through access openings 112 in the rail system 108. The container handling vehicles 201, 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201, 301, 401 comprises a vehicle body 201a, 301a, 401a and first and second sets of wheels 201b, 201c, 301b, 301c, 401b, 401c which enable the lateral movement of the container handling vehicles 201, 301, 401 in the X direction and in the Y direction, respectively. In FIGS. 2, 3 and 4 two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b, 301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201, 301, 401 also comprises a lift device 404, see FIG. 4, for vertical transportation of storage containers 106 (i.e. a container lift device), e.g. raising a storage container 106 from, and lowering a storage container 106 into, a storage column 105. The lift device 404 features a lifting frame 404d comprising container connectors 404b and guiding pins 404c adapted to engage a storage container 106. The lifting frame 404d can be lowered from the vehicle 201, 301, 401 so that the position of the lifting frame 404d with respect to the vehicle 201, 301, 401 can be adjusted in a third direction Z which is orthogonal the first direction Y and the second direction X. The lifting device of the container handling vehicle 201 is located within the vehicle body 201a in FIG. 2.

To raise or lower the lifting frame 404d (and optionally a connected storage container 106), the lifting frame 404d is suspended from a band drive assembly by lifting bands 404a. In the band drive assembly, the lifting bands are commonly spooled on/off at least one rotating lifting shaft or reel arranged in the container handling vehicle. Various designs of band drive assemblies are described in for instance WO 2015/193278 A1, WO 2017/129384 A1 and WO 2019/206438 A1.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a, 401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The lateral area defined by a storage column is equal to the lateral area defined by a grid cell 122 of the rail system 108. The lateral area of a grid cell includes the area of the access opening 112 and half the width of the rails at the periphery of the access opening.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110, 111 may comprise two parallel tracks. In other rail systems 108, each rail in one direction (e.g. an X direction) may comprise one track and each rail in the other, perpendicular direction (e.g. a Y direction) may comprise two tracks. Each rail 110, 111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301, 401 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different levels, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301, 401 to a location above the storage column 105 in which the target storage container 106 is positioned, retrieving the storage container 106 from the storage column 105 using the container handling vehicle's 201, 301, 401 lift device 404, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles.

Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original 25 storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201, 301, 401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201, 301, 401 so that a desired storage container 106 can be delivered to the desired location at the desired time without 40 the container handling vehicles 201, 301, 401 colliding with each other, the automated storage and retrieval system 1 comprises a control system 500 which typically is computerized and which typically comprises a database for keeping track of the storage containers 106.

The prior art container-handling vehicles 201, 301, 401 described above may handle and transport only one storage container 106 in each operation, thereby setting a limitation on the efficiency of certain operations performed by the storage system, including retrieval and/or storage of multiple storage containers and “digging”.

A container-handling vehicle for handling and transporting a plurality of storage containers is disclosed in WO 2019/101366 A1. The vehicle features at least two lifting devices and can handle/transport a single storage container for each lifting device.

In view of the above, it is desirable to provide a more efficient container-handling vehicle, an automated storage and retrieval system comprising said container-handling vehicle, and a method for operating such a system.

### SUMMARY OF THE INVENTION

The present invention is defined in the attached claims and in the following:

In a first aspect, the present invention provides a container handling vehicle for moving in two perpendicular horizontal directions on a rail system, the rail system comprising a first set of parallel rails and a second set of parallel rails arranged perpendicular to the first set of rails, the container handling vehicle comprising
a vehicle frame;
a base;
an internal space defined by the vehicle frame and the base, the base providing at least one storage section upon which at least two storage containers stacked on top of each other may be supported;
a lifting device comprising a vertically moveable lifting frame for releasably connecting to a storage container and
an opening allowing vertical passage of the lifting frame between the internal space and a position below the base;

wherein the lifting device is configured to be horizontally moveable between a position above the opening and a position above the at least one storage section.

The base may be fixed relative to the vehicle frame. The base may comprise any structural element (such as a floor, brackets and/or bars) suitable for providing the at least one storage section upon which a storage container may be supported. The base may also be termed a floor.

The at least one storage section may feature a horizontal surface area of the base having a size at least equal to a horizontal periphery of a storage container.

The lifting device may be arranged in an upper portion of the container handling vehicle and/or an upper portion of the internal space.

The opening may have a horizontal inner periphery larger than a horizontal outer periphery of the lifting frame. The opening may be arranged in the base.

In an embodiment, the container handling vehicle may comprise a plurality of storage sections and the lifting device is configured to be horizontally moveable between a position above the opening and a position above any one of the storage sections. The plurality of storage sections may be arranged adjacent to each other.

In an embodiment, the container handling vehicle may comprise a first storage section and a second storage section, wherein the lifting device is configured to be moveable in a first horizontal direction between the position above the opening to a first position above the first storage section and in a second horizontal direction between the position above the opening to a second position above the second storage section.

In an embodiment of the container handling vehicle, the second horizontal direction may be perpendicular to the first horizontal direction.

In an embodiment of the container handling vehicle, the lifting device may comprise a trolley being moveably connected at an upper portion of the container handling vehicle, such that the trolley may move in the first horizontal direction relative to the base. The trolley may alternatively be termed a shuttle

In an embodiment of the container handling vehicle, the trolley may comprise at least one lifting shaft, and the lifting frame is suspended from the at least one lifting shaft by lifting bands that may be spooled on or off the lifting shaft to raise or lower the lifting frame relative to the trolley.

In an embodiment of the container handling vehicle, the trolley may be moveably connected at the upper portion of the container handling vehicle, such that the trolley may move in the second horizontal direction relative to the base, the second horizontal direction being perpendicular to the first horizontal direction.

In an embodiment of the container handling vehicle, the trolley may be moveably connected to a gantry element at the upper portion of the container handling vehicle, the gantry element being moveably connected to the upper portion of the container handling vehicle, such that the gantry element and the trolley may move in the second horizontal direction relative to the base.

The trolley and the gantry element may be moveably connected by any suitable configuration providing a linear horizontal movement, such as a rail/wheel connection. The trolley may for instance comprise wheels running on rails provided on the gantry element. Similarly, the gantry element may comprise wheels running on rails provided at the upper portion of the vehicle. The linear movements of the trolley and the gantry element may be provided by at least one electric motor, a motorized wheel or a linear actuator.

In an embodiment, the container handling vehicle may comprise a third storage section, wherein the lifting device may be moved in the second horizontal direction between the first position above the first storage section and a third position above the third storage section.

In an embodiment of the container handling vehicle, a vertical distance between the base and the lifting frame, when the lifting frame is in an upper position, may be configured to allow at least two storage containers to be stacked on top of each other while they are supported upon the at least one storage section.

In other words, when the lifting frame is in an upper position, the lifting frame may be moved to a position above a stack of at least two storage containers supported upon the storage section to connect with the upper storage container of the stack.

In an embodiment, the container handling vehicle may comprise vertical guide profiles extending from the base, the guide profiles are arranged at at least two corner positions of the at least one storage section and are configured to prevent horizontal movement of a storage container supported upon the at least one storage section. At least one of the guide profiles may form an integral part of the vehicle frame to increase the structural strength of the vehicle frame.

The container handling vehicle may comprise two adjacent storage sections, and one of the vertical guide profiles may extend between the storage sections to support storage containers supported upon any of the two storage sections.

In an embodiment, the container handling vehicle may comprise a wheel assembly configured for moving the vehicle along any of the first set of parallel rails and the second set of parallel rails, the wheel assembly comprising at least four wheels.

The at least four wheels may be pivotable around a vertical axis to allow movement along any of the first set of parallel rails and the second set of parallel rails, or may be part of a first set of wheels arranged to engage with the first set of rails, and a second set of wheels arranged to engage with the second set of rails, wherein at least one of the sets of wheels can be lifted and lowered, so that the first set of wheels and/or the second set of wheels can be engaged with the respective set of rails at any one time.

In an embodiment, the container handling vehicle, the base is arranged at a level below an upper level of the at least four wheels. In other words, the base is configured such that the storage sections will support the storage containers at a level being below an upper level of the wheels.

In a second aspect, the present invention provides a storage system comprising a container handling vehicle according to any embodiment of the first aspect, the storage system comprises a framework structure having a plurality of storage columns for accommodating a vertical stack of storage containers, and a rail system upon which the container handling vehicle may move in two perpendicular directions above the storage columns.

In an embodiment of the storage system, the rail system comprises a first set of parallel rails and a second set of parallel rails arranged perpendicular to the first set of rails, providing a horizontal grid-based rail system defining a plurality of grid cells, above which grid cells the opening may be arranged to allow movement of the lifting frame between the internal space and the storage columns. A grid cell may be defined as the cross-sectional area between the vertical centre planes of opposed rails running in the X direction and opposed rails running in the Y direction. A grid cell opening may be defined as the open cross-sectional area between two opposed rails running in the X direction and two opposed rails running in the Y direction.

In an embodiment, the storage system comprises a plurality of upright members and each storage column is defined by four of the upright members.

In an embodiment of the storage system, the rail system is arranged on top of the upright members.

In an embodiment of the storage system, the footprint of the container handling vehicle may have a size of at least two grid cells of the rail system, at least three grid cells or at least four grid cells. The latter footprint may preferably cover an area of at least two by two grid cells.

In a third aspect, the present invention provides a method of retrieving storage containers in a storage system according to any embodiment of the second aspect, the method comprising the steps of:
moving the container handling vehicle to arrange the opening above a storage column accommodating a stack of storage containers;
lowering the lifting frame through the opening and into the storage column;
connecting the lifting frame to a first storage container of the stack;
raising the lifting frame and the connected first storage container into the internal space;
moving the lifting frame in a horizontal direction between the position above the opening and the position above the at least one storage section;
lowering the lifting frame until the connected first storage container is supported on the at least one storage section;
disconnecting the first storage container from the lifting frame; and
moving the lifting frame to the position above the opening.

In the first step, the opening of the container handling vehicle may be aligned with a grid cell opening of the rail system.

In an embodiment, the method may comprise the additional steps of:
lowering the lifting frame through the opening and into the storage column;
connecting the lifting frame to a second storage container of the stack;
raising the lifting frame and the connected second storage container into the internal space;
moving the lifting frame in a horizontal direction between the position above the opening and the position above the at least one storage section;
lowering the lifting frame until the connected second storage container is supported on the first storage container;
disconnecting the second storage container from the lifting frame; and
moving the lifting frame to the position above the opening.

In an embodiment of the method, wherein the container handling vehicle comprises a first storage section, on which the first storage container is supported, and a second storage section, and the lifting frame is configured to be moveable in a first horizontal direction between the position above the opening to a first position above the first storage section, and in a second horizontal direction between the position above the opening to a second position above the second storage section, the method may comprise the additional steps of:
lowering the lifting frame through the opening and into the storage column;
connecting the lifting frame to a third storage container of the stack;
raising the lifting frame and the connected third storage container into the internal space;
moving the lifting frame in the second horizontal direction between the position above the opening and the position above the second storage section;
lowering the lifting frame until the connected third storage container is supported on the second storage section;
disconnecting the third storage container from the lifting frame; and
moving the lifting frame to the position above the opening.

In an embodiment of the method, the second horizontal direction may be perpendicular to the first horizontal direction.

### BRIEF DESCRIPTION OF THE DRAWINGS

Embodiments of the present invention are described in detail by way of example only and with reference to the following drawings:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIGS. 5-7 are perspective views of an exemplary container handling vehicle according to the invention.

FIGS. 8-9 are sectional top views of the container handling vehicle in FIGS. 5-7.

FIG. 10 is a perspective view of an upper section of the container handling vehicle in FIGS. 5-7.

FIGS. 11-15 are perspective views of the container handling vehicle in FIGS. 5-7 accommodating a plurality of storage containers.

FIGS. 16-17 are sectional views of the wheel assembly of the container handling vehicle in FIGS. 5-7.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

As mentioned above, it would be highly advantageous to have a container handling vehicle that can handle and transport a plurality of storage containers in an efficient manner.

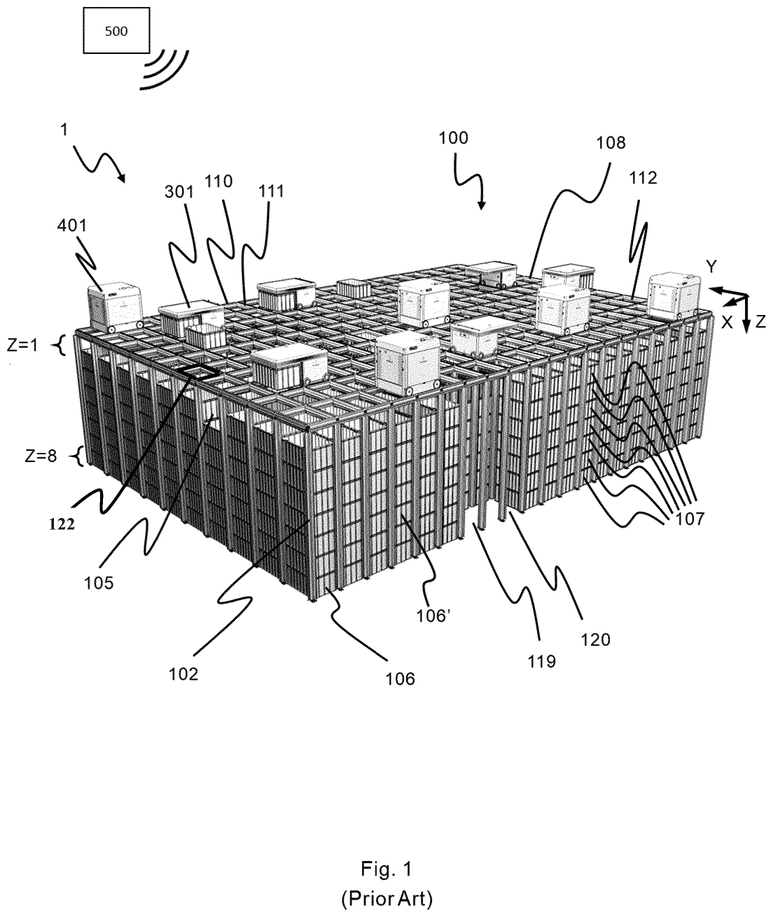

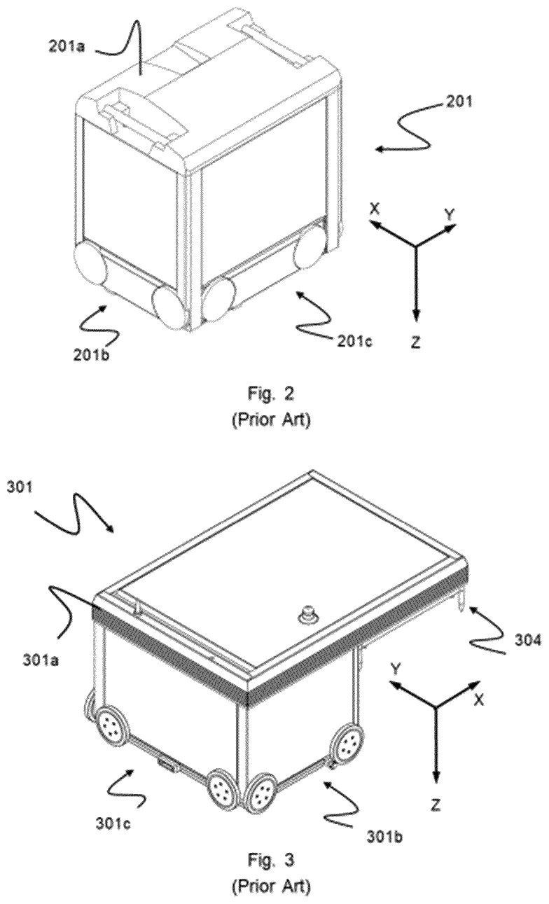

The container handling vehicle according to the invention is intended for use in automated storage and retrieval systems, also termed a container handling system, having a framework structure 100 as described above in connection with FIGS. 1-3. The framework structure 100 comprises a plurality of upright members 102 (i.e. vertical column profiles) and a rail system 108 forming a rail grid extending in the first direction X and the second direction Y. The rail system 108 features a first set of parallel rails 110 in the first direction and a second set of parallel rails 111 in the second direction. The upright members 102 define storage columns 105 in which storage containers 106 may be stacked on top of each other. The storage containers of the automated storage and retrieval system may be configured to fulfil various functions, such as storage of items and goods and growth modules for plants. In the latter case, the automated storage and retrieval system may also be termed a vertical farming system.

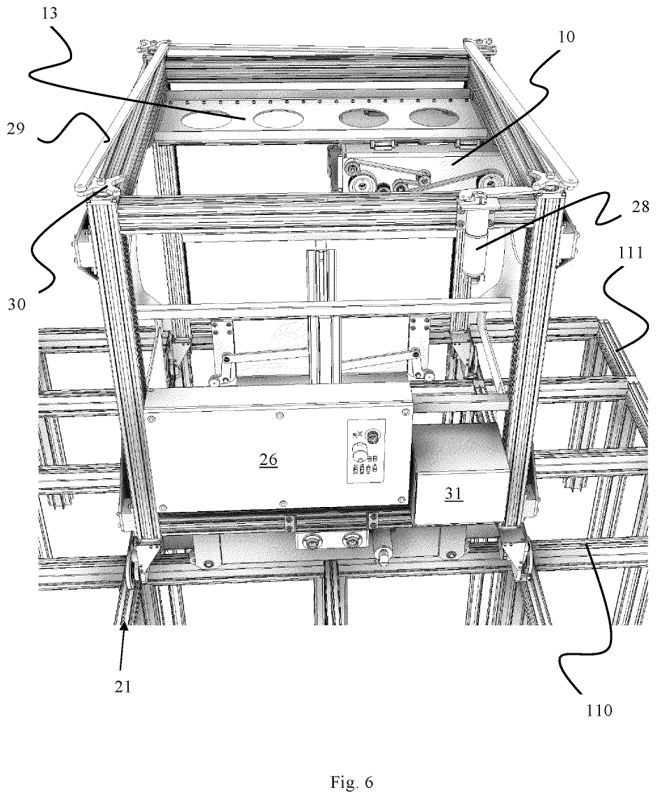

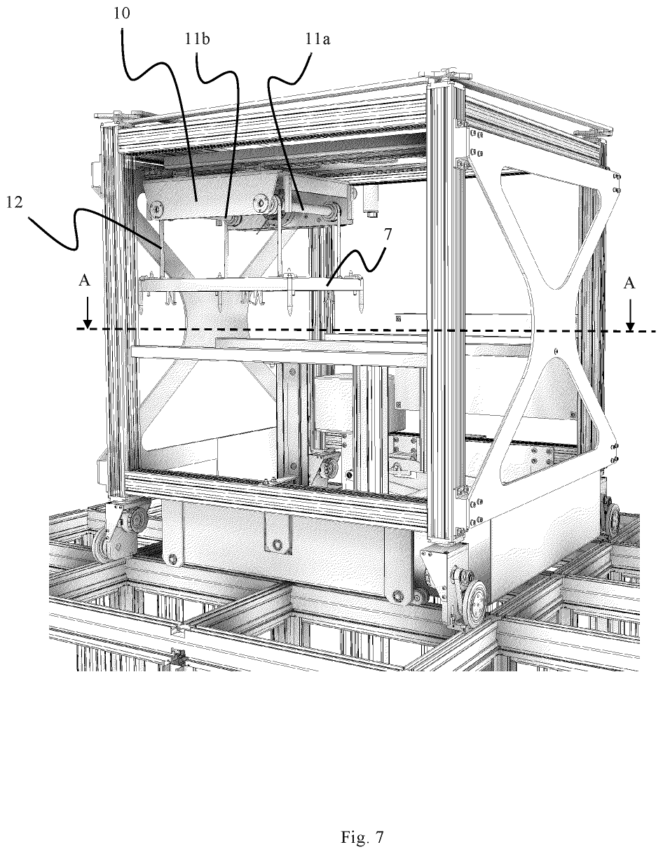

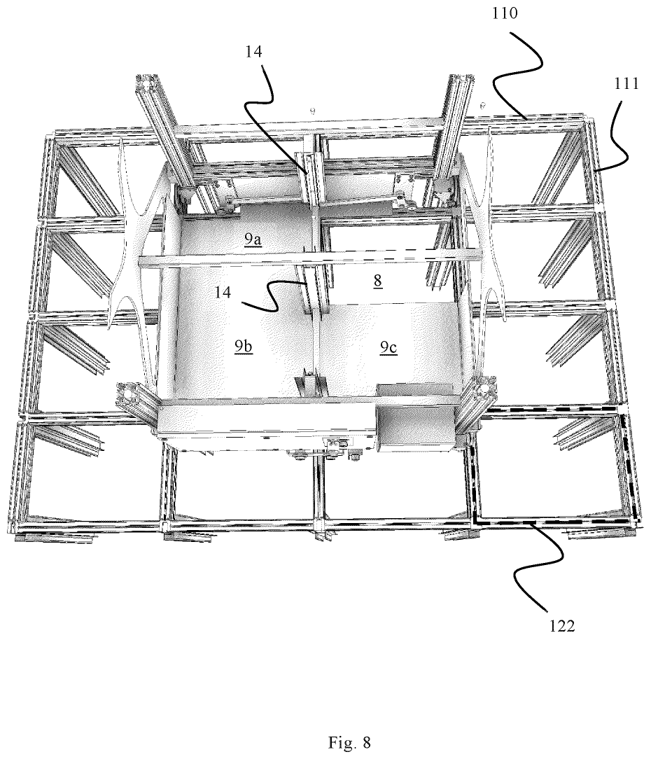

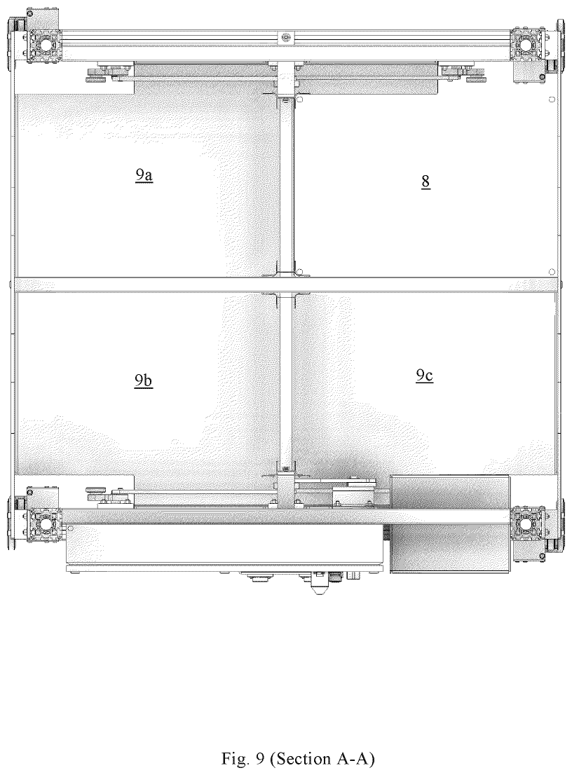

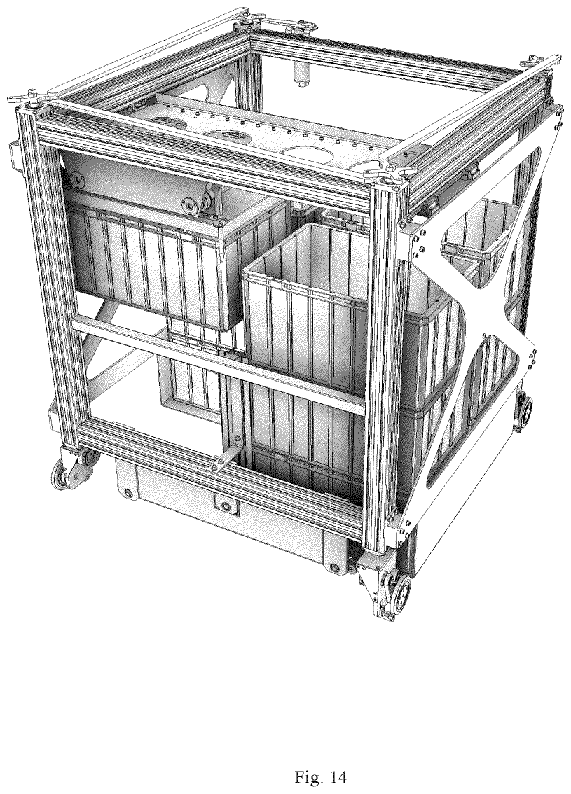

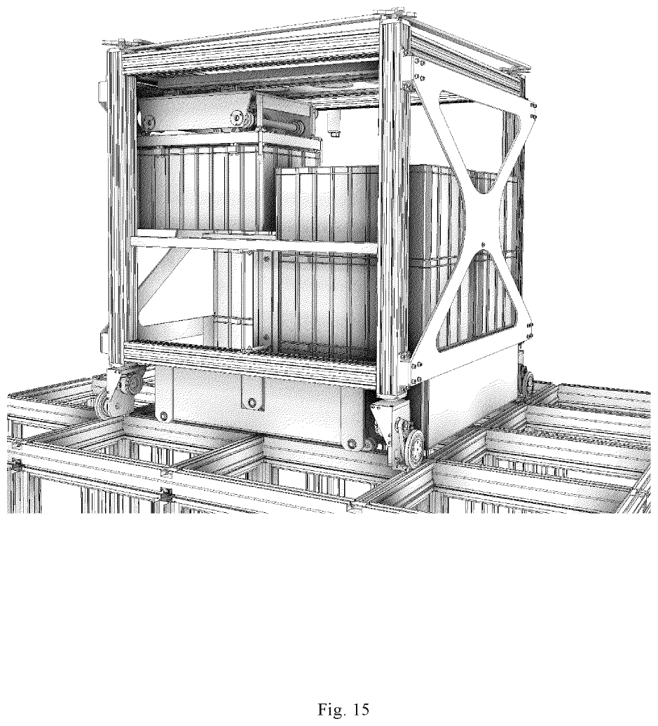

An exemplary embodiment of a container handling vehicle 2 according to the invention is shown in FIGS. 5-17.

The container handling vehicle 2 has a vehicle frame 4 and a base 6. An internal space 5 of the vehicle is defined by the vehicle frame 4 and the base 6. The base 6 provides a first storage section 9a, a second storage section 9b and a third storage section 9c (i.e. at least one storage section). A stack of three storage containers (i.e. at least two storage containers) may be supported upon each of the storage sections 9a-9c.

The vehicle features a lifting device 7, 10 for moving storage containers between a storage column 105 of a container storage system and the storage sections 9a-9c arranged in the internal space 5.

The lifting device features a vertically moveable lifting frame 7 and a trolley 10. The lifting frame 7 is for releasably connecting to a storage container 106 and is similar to the lifting frame of the prior art vehicles 201, 301, 401.

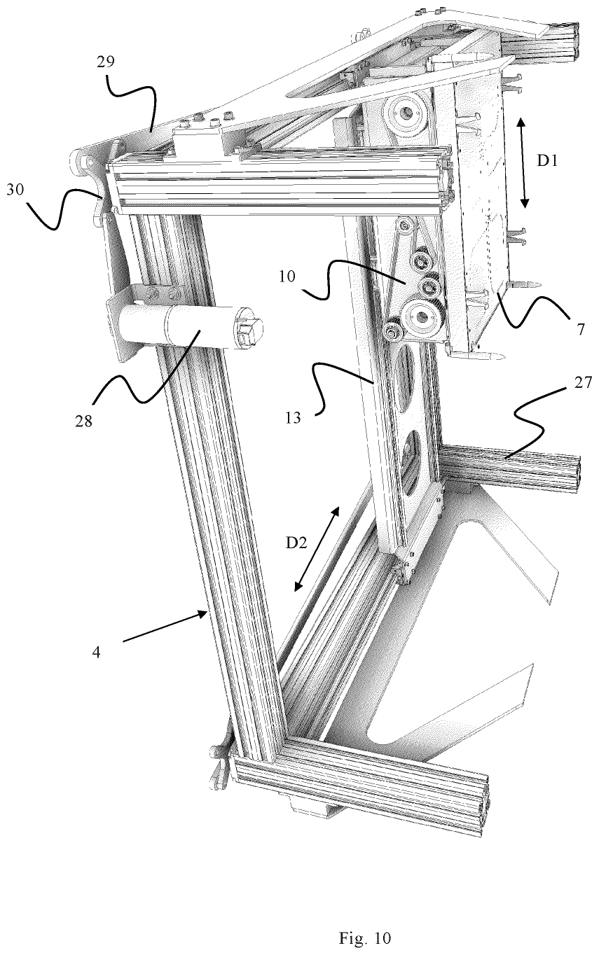

The trolley 10 is moveably connected to a gantry element 13 at an upper portion of the container handling vehicle 2, such that the trolley 10 can move in a first horizontal direction D1 relative to the gantry element 13 and the base 6, see FIG. 10. The gantry element 13 may move in a second horizontal direction D2, being perpendicular to the first horizontal direction D1, relative to the base 6. In this manner, the trolley 10 and the lifting frame 7 may move in both the first horizontal direction D1 and the second horizontal direction D2 relative to the base 6.

The trolley 10 comprises two lifting shafts 11a, 11b (i.e. at least one lifting shaft), and the lifting frame 7 is suspended from the lifting shafts by lifting bands 12. The lifting bands 12 may be spooled on or off the lifting shafts 11a, 11b to raise or lower the lifting frame 7 relative to the trolley 10. By moving the trolley 10 in the first and second horizontal directions, the lifting frame may be moved between positions above any of the storage sections 9a-c and an opening 8 arranged in the base 6. In alternative embodiments, the trolley 10 may for instance feature a single lifting shaft to which four lifting bands are connected and a plurality of direction changing elements such as sheaves to direct the lifting bands between the trolley and the lifting frame.

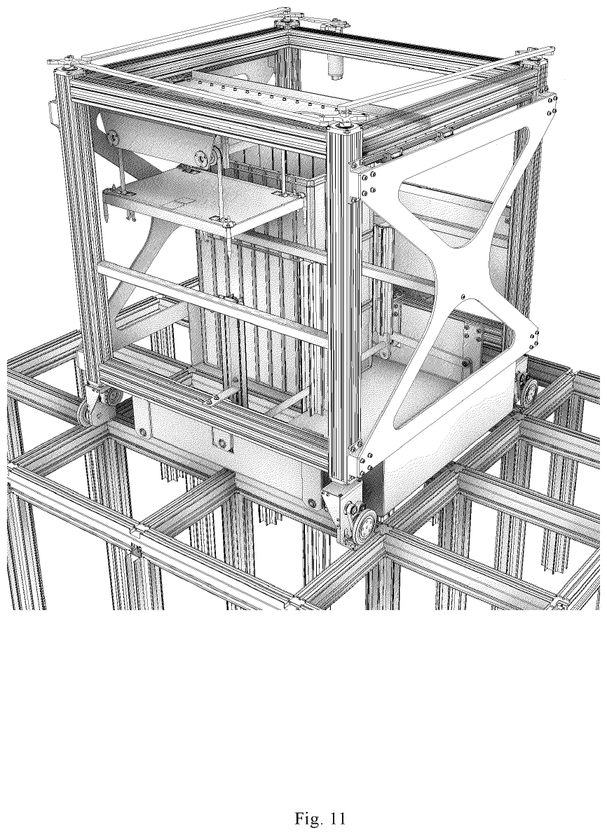

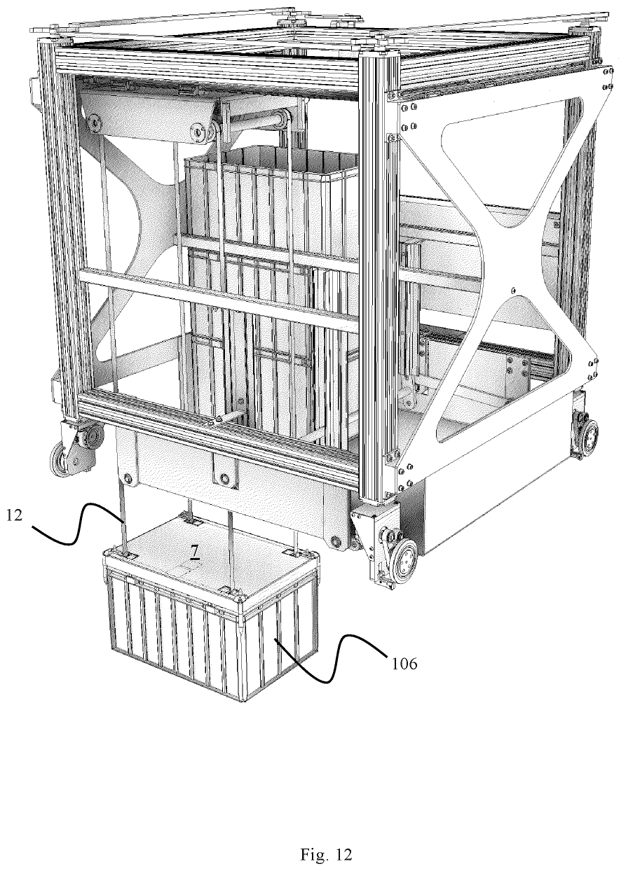

The opening 8 allows vertical passage of the lifting frame 7 between the internal space 5 and a position below the base 6. In other words, the opening allows the lifting frame 7 to be lowered into a storage column 105 arranged below the opening 8, see FIGS. 11 and 12 (the rail system 108 and storage column 105 are not shown).

In the illustrated embodiment, a vertical distance between the base 6 and the lifting frame 7, when the lifting frame 7 is in an upper position as in FIG. 10, is configured to allow three storage containers 106 to be stacked on top of each other while they are supported upon one of the storage sections 9a-c.

Vertical guide profiles 14 are arranged within the internal space 5. The vertical guide profiles 14 extend from the base 6. The guide profiles 14 are arranged at corner positions of the storage sections 9a-c to prevent or minimize horizontal movement of a storage container 106 supported upon the storage sections. The guide profiles may also be configured to interact with guide pins 15 of the lifting frame 7 such that the lifting frame may be guided into alignment with a storage container supported upon the storage sections. The guide profiles 14 are configured (i.e. have a height) such that the lifting frame 7, when connected to a storage container 106, may pass above the guide profiles 14 when the lifting frame 7 is in the upper position.

The illustrated container handling vehicle 2 features a wheel assembly configured for moving the vehicle 2 along any of the first set of parallel rails 110 and the second set of parallel rails 111. The wheel assembly comprises rail engaging supports 16 for supporting the vehicle on the rail system 108 and four wheel modules 17.

The rail engaging supports 16 are arranged at two opposite sides of the vehicle frame 4.

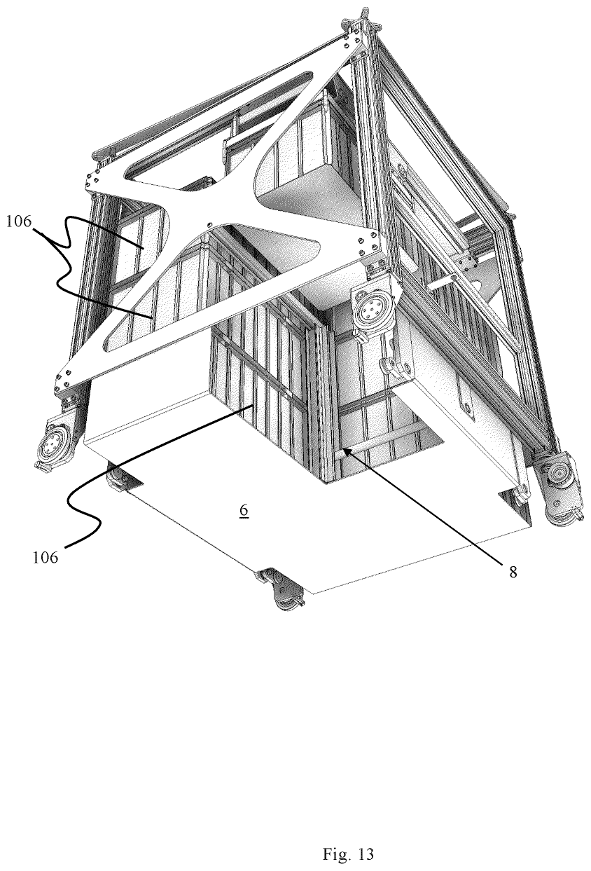

The illustrated container handling vehicle 2 is configured to accommodate up to 9 storage containers 106 supported on the storage sections 9a-c in addition to a storage container connected to the lifting frame 7, see FIGS. 13-15. In further embodiments, the storage capacity of the container handling vehicle may be configured as desired, only being dependent on the footprint and height of the vehicle. The container handling vehicle may have a footprint corresponding to at least two grid cells of the rail system, preferably at least three grid cells. The latter will allow at least each of two storage containers to be supported upon separate storage sections. The height of the internal space 5 of the container handling vehicle may be sufficient to allow at least one storage container to be supported on each of two storage sections, preferably to allow at least two storage containers stacked on top of each other to be supported on each of two storage sections.

The wheel modules 17 are arranged at lower corner sections of the vehicle frame 4. Each wheel module 17 has a wheel 18 with a horizontal axis of rotation, and the wheel 18 is allowed to pivot 90 degrees around a vertical axis such that the wheel may change its rotational direction between the first direction X and the second direction Y upon the rail system 108. At least one of the wheel modules 17 features a wheel motor 19 and a sensor 20.

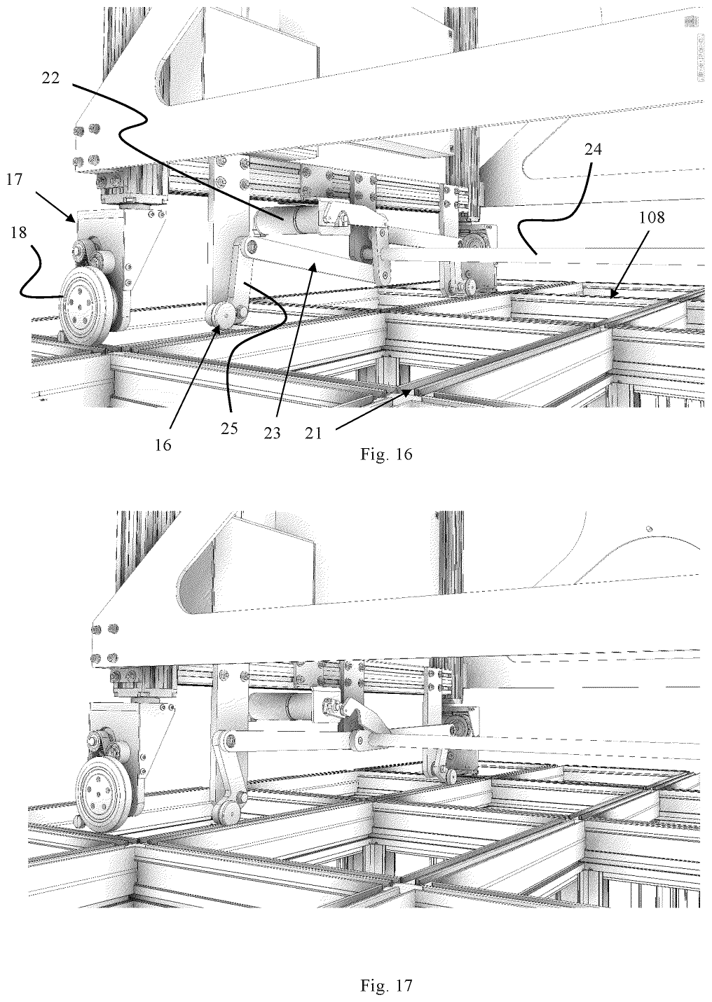

During movement of the vehicle 2 upon the rail system, the wheels are guided by wheel tracks 21 of the first or second set of rails 110, 111. To allow the wheel modules 17 to pivot, i.e. to change the direction in which the container handling vehicle 2 may travel, the wheel modules 17 and the rail engaging supports 16 are vertically moveable relative to each other between a first position and a second position, see FIGS. 16 and 17.

In the first position, see FIG. 16, the wheels 18 are arranged to engage the rail system 108 and the rail engaging supports 16 are clear of the rail system. In other words, a lower level of the wheels 18 is arranged below a lower portion of the rail engaging supports 16, such that the wheels 18 may engage the rail system 108 while the rail engaging supports 16 are clear of the rail system 108.

In the second position, see FIG. 17, the rail engaging supports 16 are arranged to engage the rail system and the wheels 18 are lifted clear of the rail system 108, such that the wheels 18 may pivot around the vertical axis to change the rotational direction between the first direction X and the second direction Y. In other words, the lower portion of the rail engaging supports 16 is below a lower level of the wheels 18, such that the rail engaging supports 16 may engage the rail system 108 while the wheels 18 are lifted clear of the rail system 108 to allow the wheels to pivot around the vertical axis without interacting with the rail system. The wheels 18 may be pivoted by operating a wheel pivoting assembly as discussed below.

The rail engaging supports 16 are connected to an actuator assembly configured to move the rail engaging supports 16 in a vertical direction relative to the vehicle frame 4 and the wheel modules 17. The actuator assembly comprise an electric motor 22 (i.e. an actuator), a linkage arrangement 23 on each of two opposite sides of the vehicle frame 4 and a shaft 24 interconnecting the two linkage arrangements 23. Each of the linkage arrangements is coupled to two lever arms 25 and configured such that the lever arms 25 will pivot between the first position and the second position when the shaft 24 is rotated by operating the electric motor 22. The shaft 24 is configured to extend above a borderline between adjacent grid cells 122 when the vehicle 2 is arranged on the rail system 108.

To change the rotational direction of the wheels 18 by 90 degrees when the wheel modules 17 are in the second position, the vehicle 2 features a wheel pivoting assembly configured to pivot the wheels 18 simultaneously around the corresponding vertical axes. The wheel pivoting assembly comprises four vertical shafts (not shown), each shaft connected to a corresponding wheel module 17. The shafts extend from the wheel modules 17, through vertical profiles 27 of the vehicle frame 4 to an upper level of the vehicle frame 4. Upper ends of the vertical shafts are coupled to an electric motor 28 (i.e. a wheel pivoting actuator) via a set of links 29 and levers 30. The links 29, the levers 30 and the electric motor 28 are configured to rotate the shafts such that the wheels 18 will pivot simultaneously around the corresponding vertical axes when the electric motor 28 is operated.

To provide an optimum stability of the container handling vehicle, i.e. a low centre of gravity, the base 6 is configured such that the storage sections 9a-c will support the storage containers at a level being below an upper level of the wheels 18.

The container handling vehicle features an electronic control module 26, for wireless communication with a control system 500 of an automated storage system as described above, and a rechargeable battery 31.

The container handling vehicle according to the invention may increase the efficiency of several operations performed in an automated storage system as described above. For instance, the vehicle may perform a “digging” operation to reach a target container without having the vehicle 2 move upon the rail system 108 during the operation. Further, the vehicle 2 may be used to change the sequence in which storage containers 106 are stacked within a single storage column 105 without having the vehicle 2 move upon the rail system 108 during the operation. The vehicle 2 may also be used to transport a plurality of storage containers to/from a port area at which storage containers are transferred between the framework structure and a picking station.

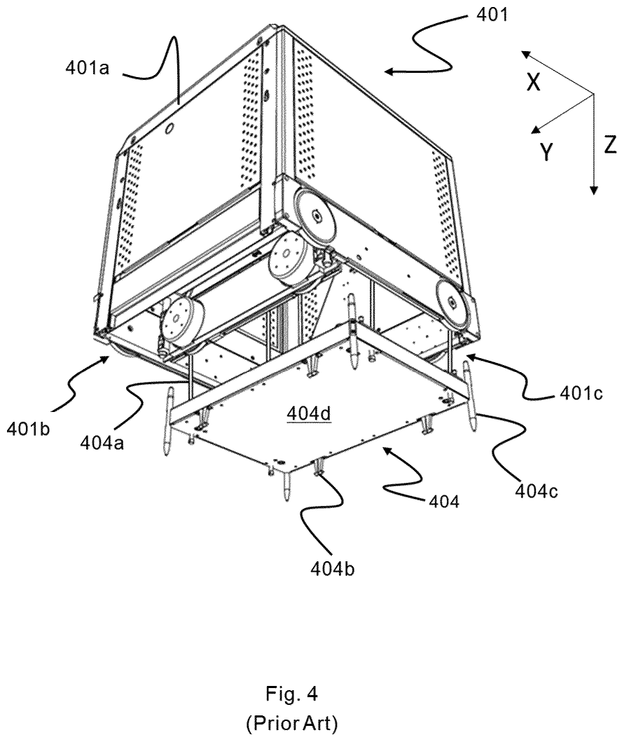

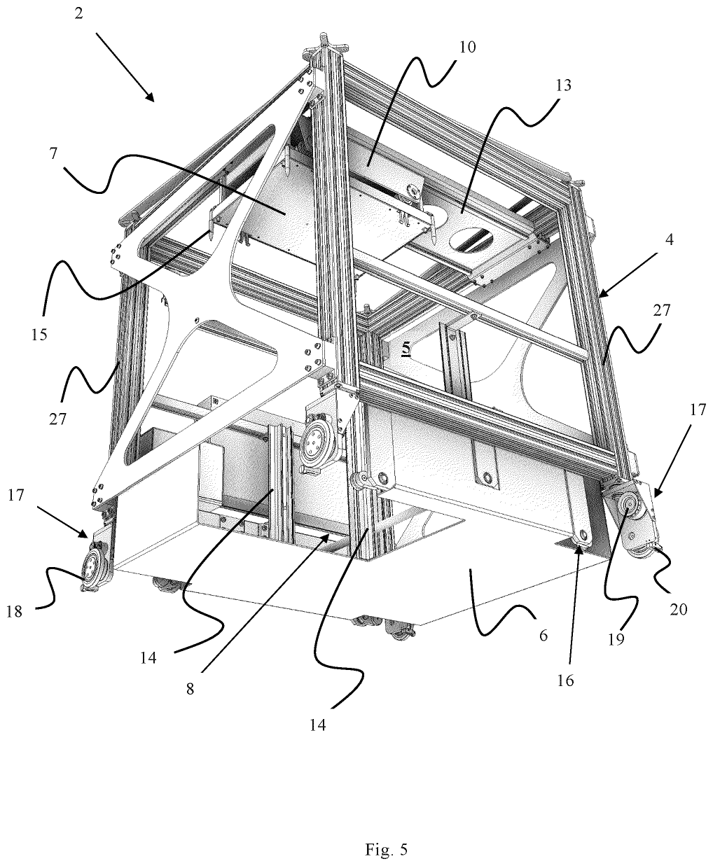

As described above, the illustrated embodiment of the inventive container handling vehicle 2 has a wheel assembly featuring four pivotable wheels 18 for moving the vehicle in two perpendicular directions upon the rail system 108. In alternative embodiments of the vehicle, the wheel assembly may instead be configured in a manner similar to the wheel assemblies of the prior art vehicles in FIGS. 2-4. In other words, the inventive vehicle may have a first set of wheels and a second set of wheels, as described above in connection with the prior art vehicles 201, 301, 401 and in for instance WO2015/193278 A1 and WO2017/153583. The first set of wheels may be arranged to engage with two parallel rails of the first set of rails 110, and the second set of wheels may be arranged to engage with two parallel rails of the second set of rails 111. At least one of the sets of wheels can be lifted and lowered, so that the first set of wheels and/or the second set of wheels can be engaged with the respective set of rails 110, 111 at any one time.

List of reference numbers

| | |
|---|---|
| 1 | Prior art automated storage and retrieval system |
| 2 | Container handling vehicle |
| 4 | Vehicle frame |
| 5 | Internal space |
| 6 | Base |
| 7 | Lifting frame |
| 8 | Opening |
| 9a-c | Storage section |
| 10 | Trolley |
| 11a-b | Lifting shaft |
| 12 | Lifting band |
| 13 | Gantry element |
| 14 | Vertical guide profiles |
| 15 | Guide pin |
| 16 | Rail engaging support |
| 17 | Wheel module |
| 18 | Wheel |
| 19 | Wheel motor |
| 20 | Sensor |
| 21 | Wheel track |
| 22 | Electric motor |
| 23 | Linkage arrangement |
| 24 | Shaft |
| 25 | Lever arm |
| 26 | Electronic control module |
| 27 | Vertical profile |
| 28 | Electric motor |
| 29 | Link |
| 30 | Lever |
| 31 | Rechargeable battery |
| 100 | Framework structure |
| 102 | Upright members of framework structure |
| 104 | Storage grid |
| 105 | Storage column |
| 106 | Storage container |
| 106′ | Particular position of storage container |
| 107 | Stack |
| 108 | Rail system |
| 110 | Parallel rails in first direction (X) |
| 112 | Access opening |
| 119 | First port column |
| 120 | Second port column |
| 201 | Prior art container handling vehicle |
| 201a | Vehicle body of the container handling vehicle 201 |
| 201b | Drive means/wheel arrangement/first set of wheels in first |
| | direction (X) |
| 201c | Drive means/wheel arrangement/second set of wheels in second |
| | direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 304 | Gripping device |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 404 | Gripping device |
| 404a | Lifting band |
| 404b | Gripper |
| 404c | Guide pin |
| 404d | Lifting frame |
| 500 | Control system |
| X | First direction |
| Y | Second direction |
| Z | Third direction |

1-19. (canceled)

20. A container handling vehicle for moving in two perpendicular horizontal directions on a rail system, the container handling vehicle comprising:
a vehicle frame;
a base;
an internal space defined by the vehicle frame and the base, the base providing at least one storage section upon which at least two storage containers stacked on top of each other may be supported;
a lifting device comprising a vertically moveable lifting frame for releasably connecting to a storage container; and
an opening allowing vertical passage of the vertically moveable lifting frame between the internal space and a position below the base;
wherein the lifting device is configured to be horizontally moveable between a position above the opening and a position above the at least one storage section.

21. The container handling vehicle according to claim 20, comprising a plurality of storage sections, and wherein the lifting device is configured to be horizontally moveable between a position above the opening and a position above any one of the plurality of storage sections.

22. The container handling vehicle according to claim 20, comprising a first storage section and a second storage section, wherein the lifting device is configured to be moveable in a first horizontal direction between the position above the opening to a first position above the first storage section and in a second horizontal direction between the position above the opening to a second position above the second storage section.

23. The container handling vehicle according to claim 22, wherein the second horizontal direction is perpendicular to the first horizontal direction.

24. The container handling vehicle according to claim 22, wherein the lifting device comprises a trolley being moveably connected at an upper portion of the container handling vehicle, such that the trolley may move in the first horizontal direction relative to the base.

25. The container handling vehicle according to claim 24, wherein the trolley comprises at least one lifting shaft, and the vertically moveable lifting frame is suspended from the at least one lifting shaft by lifting bands that may be spooled on or off the at least one lifting shaft to raise or lower the vertically moveable lifting frame relative to the trolley.

26. The container handling vehicle according to claim 24, wherein the trolley is moveably connected at the upper portion of the container handling vehicle, such that the trolley may move in the second horizontal direction relative to the base, the second horizontal direction being perpendicular to the first horizontal direction.

27. The container handling vehicle according to claim 26, wherein the trolley is moveably connected to a gantry element at the upper portion of the container handling vehicle, the gantry element being moveably connected to the upper portion of the container handling vehicle, such that the gantry element and the trolley may move in the second horizontal direction relative to the base.

28. The container handling vehicle according to claim 22, comprising a third storage section, wherein the lifting device may be moved in the second horizontal direction between the first position above the first storage section and a third position above the third storage section.

29. The container handling vehicle according to claim 20, wherein a vertical distance between the base and the vertically moveable lifting frame, when the vertically moveable lifting frame is in an upper position, is configured to allow at least two storage containers to be stacked on top of each other while they are supported upon the at least one storage section.

30. The container handling vehicle according to claim 20, comprising vertical guide profiles extending from the base, the vertical guide profiles are arranged at least two corner positions of the at least one storage section and are configured to prevent horizontal movement of a storage container supported upon the at least one storage section.

31. The container handling vehicle according to claim 20, wherein the container handling vehicle is for moving in two perpendicular horizontal directions on a rail system, wherein the rail system comprises a first set of parallel rails and a second set of parallel rails arranged perpendicular to the first set of parallel rails, the container handling vehicle comprising a wheel assembly configured for moving the container handling vehicle along any of the first set of parallel rails and the second set of parallel rails, the wheel assembly comprising at least four wheels.

32. The container handling vehicle according to claim 31, wherein the base is arranged at a level below an upper level of the at least four wheels.

33. A storage system comprising a container handling vehicle according to claim 20, wherein the storage system comprises a framework structure having a plurality of storage columns for accommodating a vertical stack of storage containers, and a rail system upon which the container handling vehicle may move in two perpendicular directions above the plurality of storage columns.

34. The storage system according to claim 33, wherein the rail system comprises a first set of parallel rails and a second set of parallel rails arranged perpendicular to the first set of parallel rails, providing a horizontal grid-based rail system defining a plurality of grid cells, above which grid cells the opening may be arranged to allow movement of the vertically moveable lifting frame between the internal space and the plurality of storage columns.

35. A method of retrieving storage containers in a storage system, comprising:
moving a container handling vehicle to arrange an opening above a storage column accommodating a stack of storage containers;
lowering a vertically moveable lifting frame through the opening and into the storage column;
connecting the vertically moveable lifting frame to a first storage container of the stack of storage containers;
raising the vertically moveable lifting frame and the connected first storage container into an internal space defined by a vehicle frame and a vehicle base;
moving the vertically moveable lifting frame in a horizontal direction between a position above the opening and a position above at least one storage section;
lowering the vertically moveable lifting frame until the first storage container is supported on the at least one storage section;
disconnecting the first storage container from the vertically moveable lifting frame; and
moving the vertically moveable lifting frame to the position above the opening.

36. The method according to claim 35, further comprising:
lowering the vertically moveable lifting frame through the opening and into the storage column;
connecting the vertically moveable lifting frame to a second storage container of the stack of storage containers;
raising the vertically moveable lifting frame and the connected second storage container into the internal space;
moving the vertically moveable lifting frame in a first horizontal direction between the position above the opening and the position above the at least one storage section;
lowering the vertically moveable lifting frame until the connected second storage container is supported on the first storage container;
disconnecting the second storage container from the vertically moveable lifting frame; and
moving the vertically moveable lifting frame to the position above the opening.

37. The method according to claim 35, further comprising:
lowering the vertically moveable lifting frame through the opening and into the storage column;
connecting the vertically moveable lifting frame to a third storage container of the stack of storage containers;
raising the vertically moveable lifting frame and the connected third storage container into the internal space;
moving the vertically moveable lifting frame in a second horizontal direction between the position above the opening and the position above a second storage section;
lowering the vertically moveable lifting frame until the connected third storage container is supported on the second storage section;
disconnecting the third storage container from the vertically moveable lifting frame; and
moving the vertically moveable lifting frame to the position above the opening.

38. A method according to claim 37, wherein the second horizontal direction is perpendicular to the first horizontal direction.
